(19) United States
(12) Patent Application Publication
(10) Pub. No.: US 2025/0137323 A1
(43) Pub. Date: May 1, 2025

(54) WINDOW BLINDS DAMPER

(71) Applicant: SHIH-MIN HUNG, Dacun Township, Changhua COUNTY (TW)

(72) Inventor: SHIH-MIN HUNG, Dacun Township, Changhua COUNTY (TW)

(21) Appl. No.: 18/385,368

(22) Filed: Oct. 30, 2023

(51) Int. Cl. E06B 9/324

(52) U.S. Cl. CPC E06B 9/324

(57) ABSTRACT

A window blinds damper has at least one damping device, at least one damper, a rewinding device, and a plurality of slats. The damping device has a main body with a damper housing having a through aperture and a securing axle. The damper has a first main body and a second main body, the first main body having a first pivot for mounting in the damper housing, and the second main body having a second pivot for mounting in the first main body. The first main body further has a steering wheel lever, a steering axle, and a first securing rod, and the second main body further has two securing spindles and a second securing rod.

### BACKGROUND OF INVENTION

### Field of Invention

The present invention relates to a window blinds damper.

### Description of Related Art

Window blinds are commonly used to block light. However, in order to adjust the light brightness, the window blinds may need to be adjusted. The conventional window blinds may be rolled up through a rope loop. In The use of rope loops may cause the risk of suffocation for young children. Therefore, structures that do not use rope loops but use the damper and the rewinding device to adjust the position of the window blinds are also widely used.

The conventional window blinds damper structure relies on a single pivoting member to resist the pull cord, so it cannot quickly limit the window blinds pull cord position, and its mechanism movement is also less able to stably limit the window blinds pull cord position. These existing known technical problems still need to be improved.

Therefore, it is desirable to provide a window blinds damper to mitigate and/or obviate the aforementioned problems.

### SUMMARY OF INVENTION

An objective of present invention is to provide a window blinds damper, which is capable of improving the above-mention problems.

In order to achieve the above mentioned objective, a window blinds damper has at least one damping device, at least one damper, a rewinding device, and a plurality of slats. The damping device has a main body with a damper housing having a through aperture and a securing axle. The damper has a first main body and a second main body, the first main body having a first pivot for mounting in the damper housing, and the second main body having a second pivot for mounting in the first main body. The first main body further has a steering wheel lever, a steering axle, and a first securing rod, and the second main body further has two securing spindles and a second securing rod. The damper employs one end of a cord that passes above the securing axle, the securing spindles, wraps around the steering wheel lever, passes above the steering axle, and then passes through the through aperture to connected to the window blinds; and another end of the cord is held by the rewinding device.

Other objects, advantages, and novel features of invention will become more apparent from the following detailed description when taken in conjunction with the accompanying drawings.

### BRIEF DESCRIPTION OF DRAWINGS

FIG. 1 is a three-dimensional view of the damping device and the damper according to a preferred embodiment of the present invention.

FIG. 2 is an exploded view of the damping device and the damper according to the preferred embodiment of the present invention.

FIG. 3 is another exploded view of the damper according to the preferred embodiment of the present invention.

FIG. 4 is a three-dimensional view of the damping device, the damper, and the rewinding device according to the preferred embodiment of the present invention.

FIG. 5 is a schematic diagram of the complete installation state according to the preferred embodiment of the present invention.

FIG. 6 is a cross-sectional view of the internal structure according to the preferred embodiment of the present invention.

FIG. 7 is a schematic diagram of the window blinds being released according to the preferred embodiment of the present invention.

FIG. 8 is a cross-sectional view showing the internal structure with the window blinds being pulled down according to the preferred embodiment of the present invention.

FIG. 9 is a schematic diagram showing the window blinds being raised according to the preferred embodiment of the present invention.

FIG. 10 is a cross-sectional view showing the internal structure while pulling up the window raised according to the preferred embodiment of the present invention.

### DETAILED DESCRIPTION OF PREFERRED EMBODIMENT

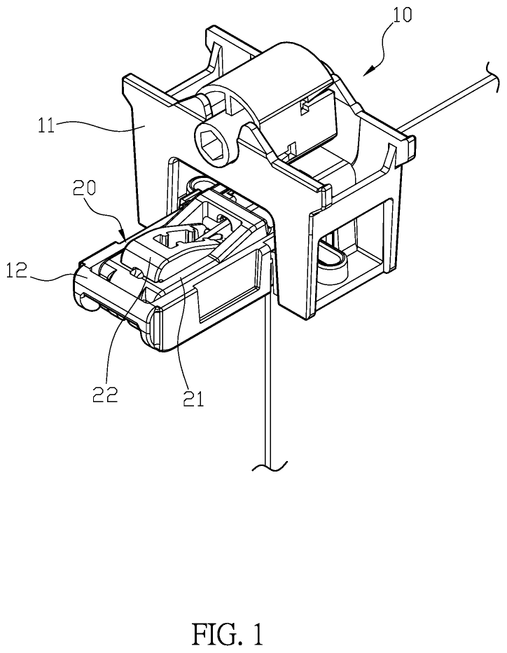

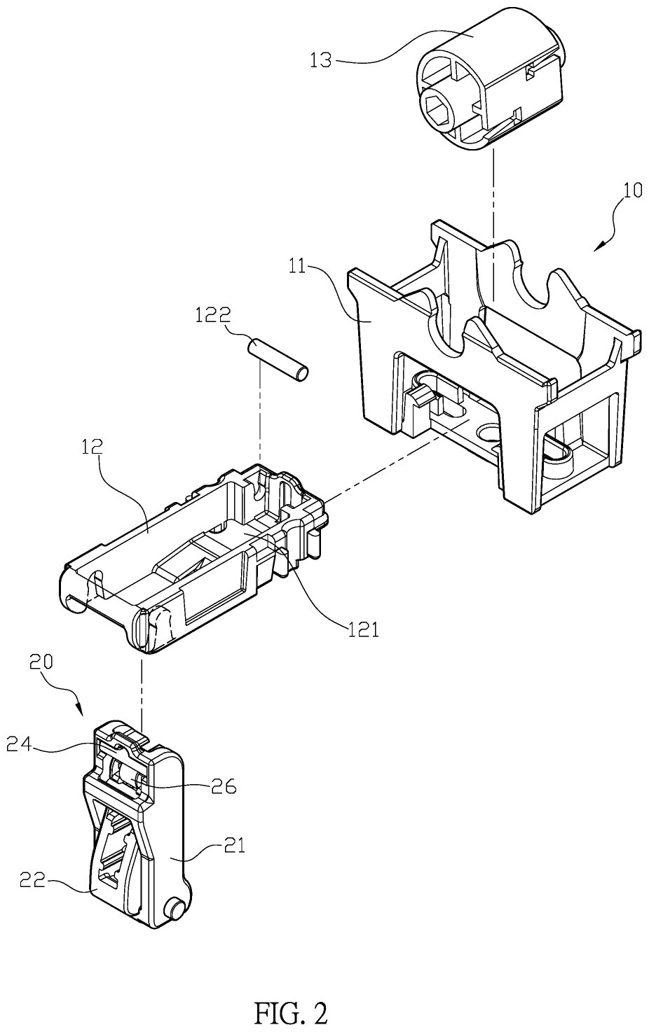

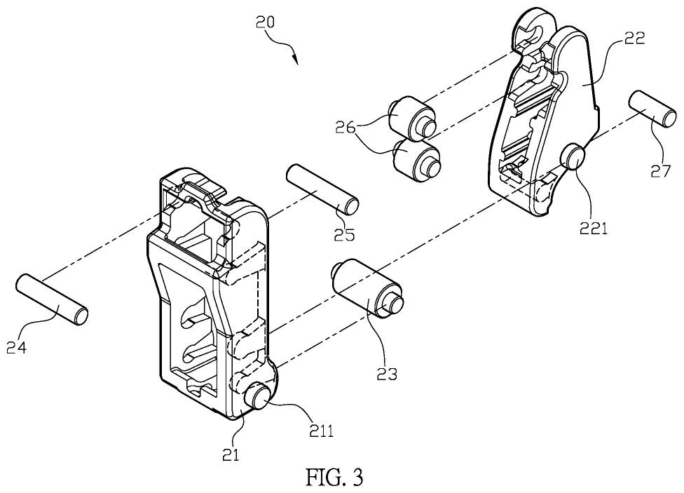

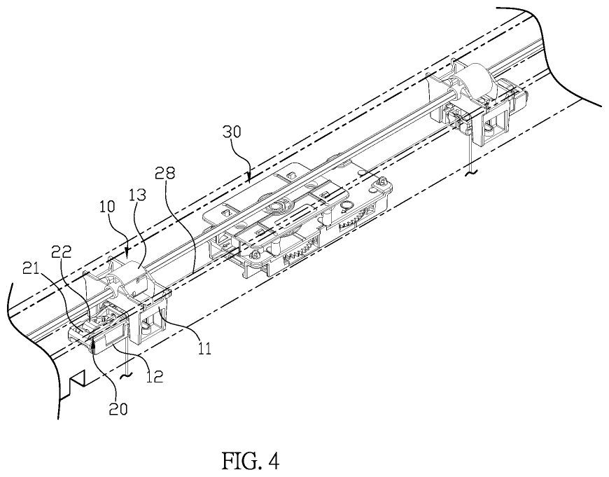

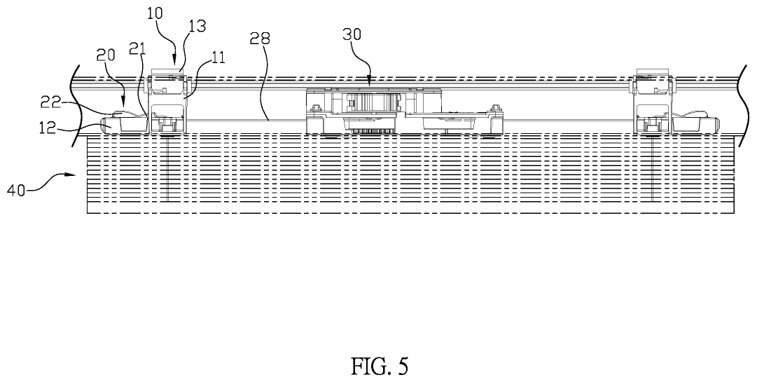

First, please refer to FIGS. 1 to 6. A window blinds damper comprises at least one damping device 10, at least one damper 20, a rewinding device 30 and a plurality of slats as window blinds 40. The damping device 10 comprises a main body 11 with a damper housing 12, and the damper housing 12 has a through aperture 121 and a securing axle 122.

The damper 20 comprises a first main body 21 and a second main body 22, the first main body 21 has a first pivot 211 for mounting in the damper housing 12, and the second main body 22 has a second pivot 221 for mounting in the first main body 21. The first main body 21 further comprises a steering wheel lever 23, a steering axle 24 and a first securing rod 25, and the second main body 22 further comprises two securing spindles 26 and a second securing rod 27. The damper 20 employs one end of a cord 28 that passes above the securing axle 122 and the securing spindle 26, wraps around the steering wheel lever 23, passes above the steering axle 24, and then passes through the through aperture 121 to connected to the window blinds 40; and another end of the cord 28 is held by the rewinding device 30.

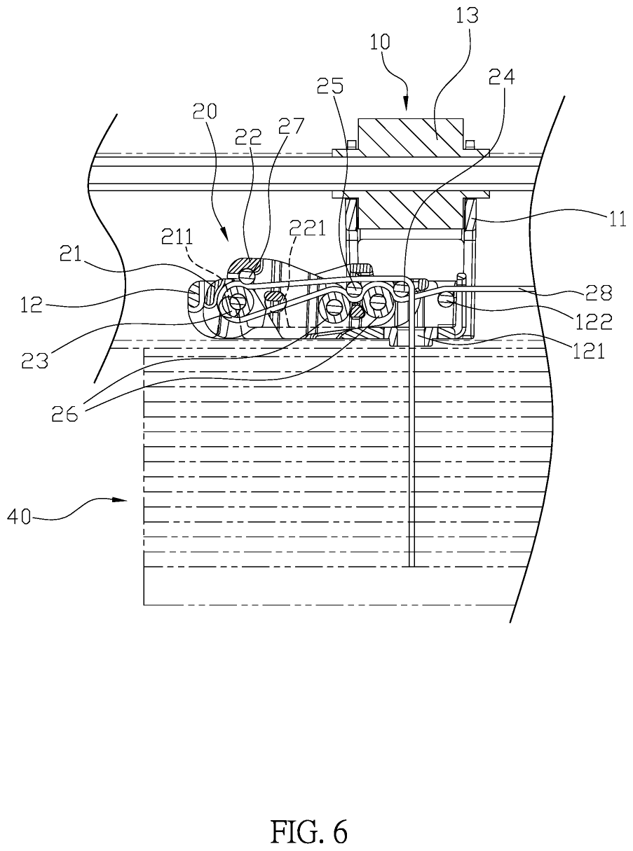

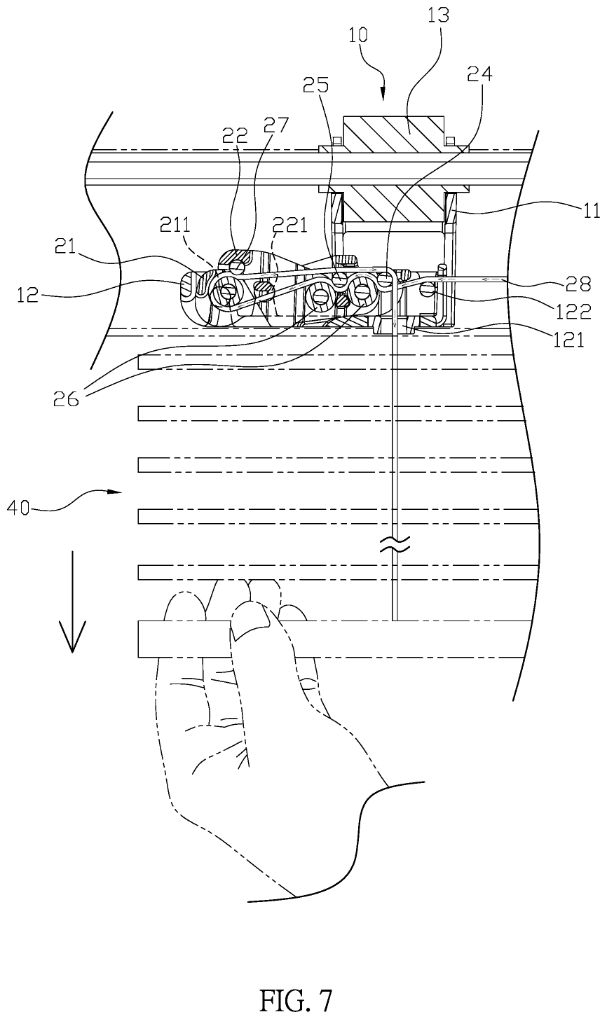

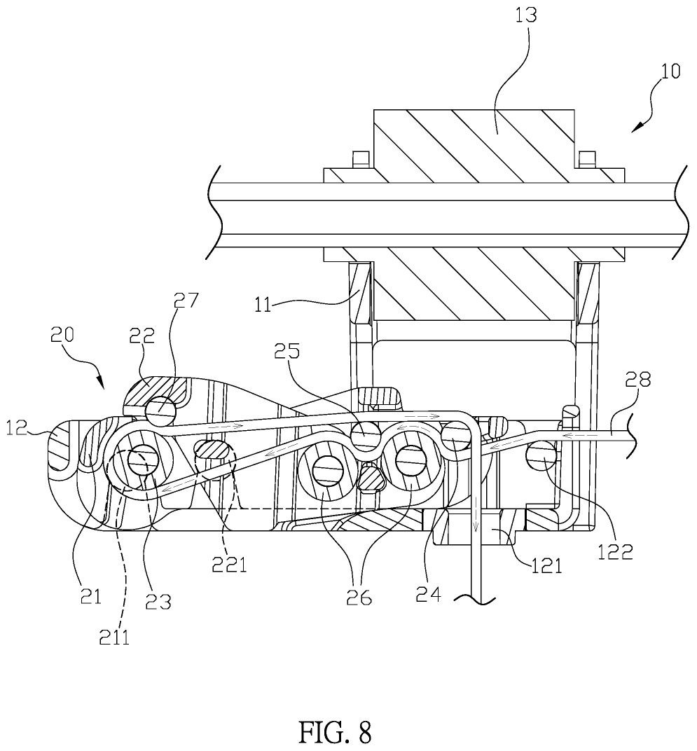

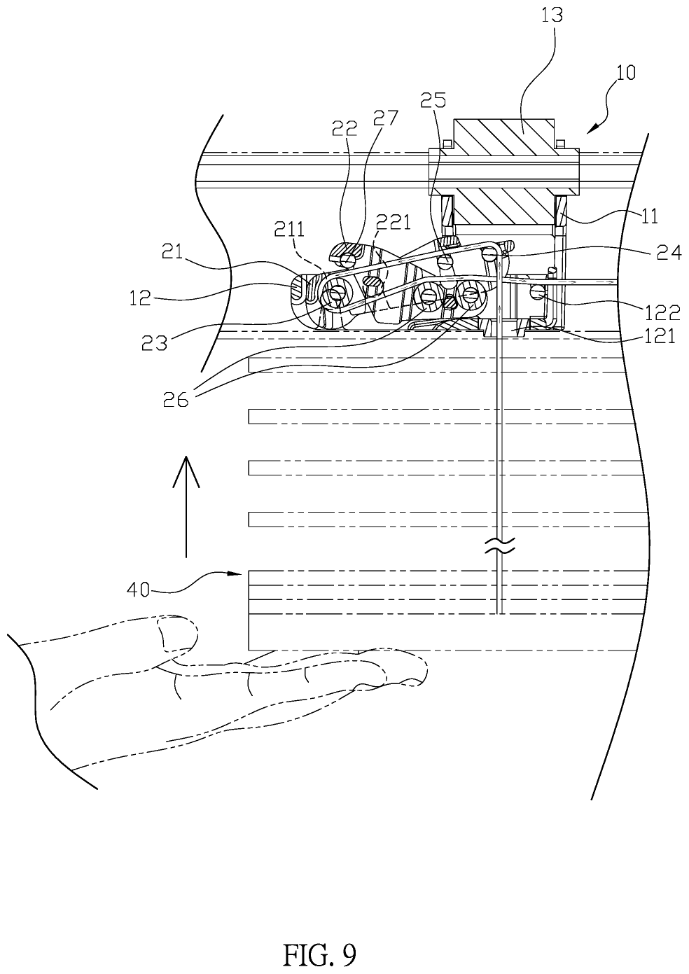

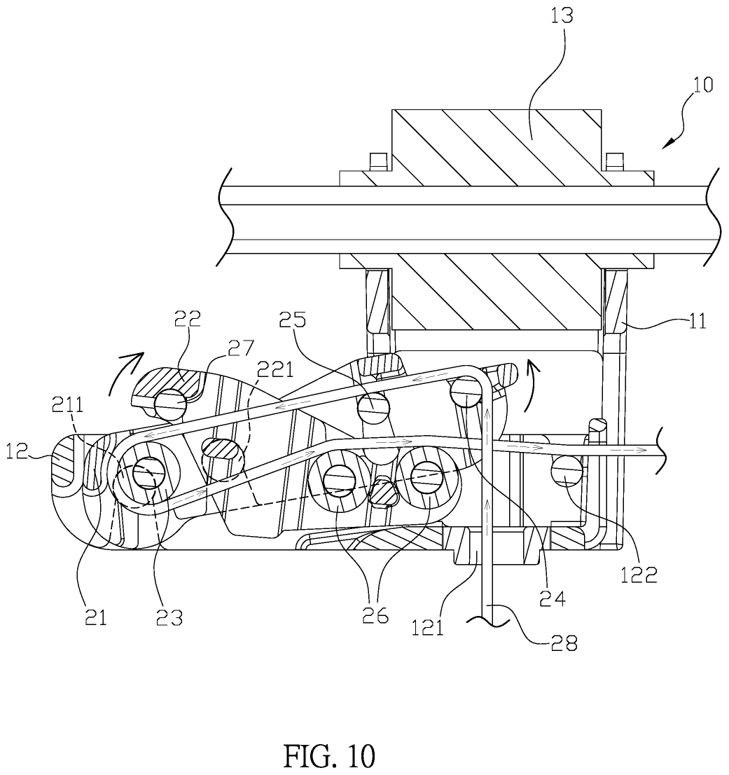

As shown in FIGS. 6 to 10, through the above structure, when the cord 28 is pulled down or pulled by the weight of the window blinds 40, the first main body 21 and the second main body 22 respectively rotate clockwise and counterclockwise downwardly in two different directions, causing the first securing rod 25 and the second securing rod 27 to press downward against the cord 28, so that the cord 28 between the second securing rod 27, the steering wheel and the lever 23, the steering axle 24, the first securing rod 25, the securing spindle 26 is entangled in an S shape and the friction is greatly increased. Therefore, the cord 28 free from the pulling force from the rewinding device 30 and restricts the position of window blinds. 40. When the cord 28 is pushed upward, the first main body 21 and the second main body 22 respectively rotate upward, and the cord 28 no longer makes contact with the first securing rod 25 and the second securing rod 27 which reduces friction so it can be easily pulled and rolled up with the rewinding device 30 to help retract the window blinds 40.

As shown in FIGS. 6 to 10, in actually operation, the first main body 21 and the second main body 22 only need to pivot upward a short distance to be away from the cord 28. Therefore, when used lift up the window blinds 40 to retract, the first securing rod 25 and the second securing rod 27 are lifted up with the help of the elasticity of the cord 28 and the pulling force of the rewinding device 30, so the first securing rod 25 and the second securing rod 27 no longer press the cord 28 to generate friction. When the cord 28 is pulled down, the first main body 21 and the second main body 22 pivot downward respectively in clockwise and counterclockwise two different directions to press onto the cord 28 which not only reduces the pivot distance to quickly restrict the cord 28 but also makes the movement of the mechanism more stable.

Furthermore, the main body 11 comprises a tilt mechanism 13 for adjusting the window blinds 40.

In addition, the window blinds 40 are Venetian blinds.

Moreover, the window blind 40 is a honeycomb curtain.

Although the present invention has been explained in relation to its preferred embodiment, it is to be understood that many other possible modifications and variations can be made without departing from the spirit and scope of invention as hereinafter claimed.

What is claimed is:

1. A window blinds damper comprising: at least one damping device, at least one damper, a rewinding device, and a plurality of slats, wherein:
the damping device comprises a main body with a damper housing having a through aperture and a securing axle;
the damper has a first main body and a second main body, the first main body having a first pivot for mounting in the damper housing, and the second main body having a second pivot for mounting in the first main body; the first main body further comprising a steering wheel lever, a steering axle, and a first securing rod; the second main body further comprising two securing spindles and a second securing rod; wherein the damper employs one end of a cord that passes above the securing axle, the securing spindles, wraps around the steering wheel lever, passes above the steering axle, and then passes through the through aperture to connected to the window blinds; and another end of the cord is held by the rewinding device.

2. The window blinds damper as claimed in claim 1, wherein the main body comprises a tilt mechanism for adjusting the window blinds.

3. The window blinds damper as claimed in claim 1, wherein the window blinds are Venetian blinds.

4. The window blinds damper as claimed in claim 1, wherein the window blind is a honeycomb curtain.
